(19) United States
(12) Patent Application Publication
(10) Pub. No.: US 2025/0145834 A1
(43) Pub. Date: May 8, 2025

(54) Oxidized Wet Beaded Carbon Black

(71) Applicant: Orion Engineered Carbons IP GmbH & Co. KG, Monheim (DE)

(72) Inventors: Ainhoa Noguera, Köln (DE); Michael Richter, Euskirchen (DE); Hauke Westenberg, Brühl (DE); Rudolf Scharffenberg-Kahlke, Euskirchen (DE); Jad Abi Haidar, Köln (DE); Ralf Bergsträsser, Elsdorf (DE)

(21) Appl. No.: 18/715,272

(22) PCT Filed: Dec. 1, 2022
(86) PCT No.: PCT/EP2022/084125

§ 371 Date: May 31, 2024

(30) Foreign Application Priority Data
Dec. 2, 2021 (EP) 21212084.4
Dec. 2, 2021 (EP) 21212085.1
Dec. 2, 2021 (EP) 21212087.7
Dec. 2, 2021 (EP) 21212088.5

(51) Int. Cl. C09C 1/56; C09C 1/58

(52) U.S. Cl. CPC C09C 1/565; C09C 1/58; C01P 2004/60; C01P 2006/12; C01P 2006/90

(57) ABSTRACT

The present invention relates to a process for the production of oxidized wet beaded carbon black. It has been found that carbon black can be wet beaded and oxidized subsequently. This process allows a better control of the degree of oxidation without damaging the beads. Moreover, the oxidized wet beaded carbon black can be beneficially used in a rubber composition to increase the properties of the resulting rubber product.

### CROSS-REFERENCE TO RELATED APPLICATIONS

This application is the United States national phase of International Patent Application No. PCT/EP2022/084125 filed Dec. 1, 2022, and claims priority to European Patent Application Nos. 21212084.4 filed Dec. 2, 2021, 21212085.1 filed Dec. 2, 2021, 21212087.7 filed Dec. 2, 2021, and 21212088.5 filed Dec. 2, 2021, the disclosures of which are hereby incorporated by reference in their entireties.

### BACKGROUND OF THE INVENTION

### Field of the Invention

The present invention relates to a process for the production of oxidized wet beaded carbon black. It has been found that carbon black can be wet beaded and oxidized subsequently. This process allows a better control of the degree of oxidation without damaging the beads. Moreover, the oxidized wet beaded carbon black can be beneficially used in a rubber composition to increase the properties of the resulting rubber product.

### Description of Related Art

Carbon blacks are fine powders that are difficult to store, transport or process. To avoid these difficulties, carbon black powders are often provided as pellets or beads having an increased bulk density.

One process to provide these beads is known as wet-beading, where the carbon black powder is agitated with water and dried afterwards. Such a process is described in GB 839,918.

Dry beading in a drum and feeding an oxidation agent directly in the dry beading drum is known in the prior art. However, this technology is not applicable for rubber customers, due to the low pellet strength of dry beaded products.

On the other hand, wet beaded carbon black can be beneficially used for rubber compositions since an increased pellet strength is achieved. The oxidation and the subsequent wet beading of carbon black are described in US 2019/0161621 A1. The produced carbon black is pulverized and subjected to a second reactor, where a carbon black/water mixture is obtained. The carbon black in the mixture is then oxidized and thereafter beaded in a pelletizer. The obtained oxidized beaded carbon black is transferred via a screw conveyer to a dryer.

However, the drawback of beading and drying the oxidized carbon black is that the degree of oxidation, i.e. the amount of function groups of the surface of the carbon black beads, is decreased during the process. Accordingly, it is difficult to control the desired degree of oxidation of the carbon black beads.

Therefore, it is an objective of the present invention to provide a versatile process that can control the degree of oxidation and having a high average pellet crush strength of the beads. Additionally, beaded and oxidized carbon black should be provided that is particularly useful for rubber compositions.

It has surprisingly been found that an oxidized wet beaded carbon black can be produced that has a high content of volatile content measured at 950° C. and at the same time a high pellet crush strength if a produced wet beaded carbon black is oxidized subsequently, particularly if a screw conveyer is used as the oxidation unit. Even if the carbon black beads have a significantly lower surface area, the oxidation of carbon black beads is possible. Furthermore, the oxidized wet beaded carbon black can be beneficially used in a rubber composition to increase the properties of the resulting rubber product.

### SUMMARY OF THE INVENTION

It has surprisingly been found that the above objective can be achieved by a process (100) for the production of oxidized wet beaded carbon black (202), preferably oxidized wet beaded carbon black (202) according to the invention such as mentioned in the aspects or claims, comprising the following steps (a) providing carbon black (101), (b) wet beading the carbon black (102) obtained in step (a) to obtain wet beaded carbon black, and (c) oxidizing the wet beaded carbon black (103) obtained in step (b) in a reaction chamber (218) to obtain oxidized wet beaded carbon black (202), preferably oxidized wet beaded carbon black (202) according to the invention such as mentioned in the aspects or claims. The process (100) for the production of oxidized wet beaded carbon black (202) is preferably carried out in a screw conveyor according to the invention.

The present invention also concerns oxidized wet beaded carbon black (202) obtained according to the inventive production of oxidized wet beaded carbon black (202). Particularly, oxidized wet beaded carbon black (202) that has a volatile content measured at 950° C. of 1 to 25 wt.-% and an average pellet crush strength of pellets with a diameter of from 0.71 to 1.0 mm of from 4 to 80 cN, preferably 5 to 40 cN, and more preferably 10 to 30 cN.

These and other optional features and advantages of the present invention are described in more detail in the following description, figures, aspects and claims.

### BRIEF DESCRIPTION OF THE DRAWINGS

FIG. 1: Process (100) for the production of oxidized wet beaded carbon black (202).

FIG. 2: Inner section of a screw conveyor (200, 300) for the production of oxidized wet beaded carbon black.

FIG. 3: Outer section of a screw conveyor (200, 300) for the production of oxidized wet beaded carbon black.

FIG. 4: Section of a conveyor screw (400).

FIG. 5: Section of a conveyor screw (500) having a second helical conveyor blade (501) forming a circumferential clearance (503).

FIG. 6: Section of a conveyor screw (600) having segments (601, 602, 603) of different helical conveyor blades (501, 502).

FIG. 7: Section of a conveyor screw (700) having a second helical conveyor blade (501) forming a circumferential clearance (503) and turners (702, 703).

FIG. 8: Section of a conveyor screw (700) having a second helical conveyor blade (501) forming a circumferential clearance (503) and turners (702, 703) including angles and the rotation direction.

FIG. 9: Image of oxidized wet beaded carbon black (202).

### DESCRIPTION OF THE INVENTION

“Carbon black” as referred to herein means a material composed substantially, e.g. to more than 80 wt. %, or more than 90 wt. % or more than 95 wt. %, based on its total weight of carbon that is produced by thermal oxidative pyrolysis or thermal cleavage of a carbon feedstock. Different industrial processes are known for the production of carbon blacks such as the furnace process, gas black process, acetylene black process, thermal black process or lamp black process. The production of carbon blacks is per se well known in the art and for example outlined in J.-B. Donnet et al., “Carbon Black: Science and Technology”, 2^{nd} edition, therefore being not described herein in more detail. Carbon black refers to carbon black in a powder form unless otherwise indicated. Wet carbon black refers to carbon black powder that comprises water and optionally binders. Beaded carbon black refers to either dry or wet beaded carbon black. Oxidized wet beaded carbon black refers to the carbon black produced according to the invention, where carbon black is first beaded and subsequently oxidized, unless otherwise indicated. The term beads and pellets are used synonymously. Oxidized carbon blacks generally have a notable oxygen content and have oxygen-containing functional groups, which can be exemplified, but are not limited to, quinone, carboxyl, phenol, lactol, lactone, anhydride and ketone groups. The screw conveyor according to the invention is a screw conveyor designed for the oxidation of carbon black beads. Diameter always refers to the inner diameter unless otherwise indicated.

As mentioned above, the present invention relates to a process for the production of oxidized wet beaded carbon black, preferably oxidized wet beaded carbon black according to the invention such as mentioned in the aspects or claims, comprising the following steps: (a) providing carbon black. (b) wet beading the carbon black obtained in step (a) to obtain wet beaded carbon black, and (c) oxidizing the wet beaded carbon black obtained in step (b) in a reaction chamber to obtain oxidized wet beaded carbon black, preferably oxidized wet beaded carbon black according to the invention such as mentioned in the aspects or claims. Accordingly, it is possible to provide a process, where the carbon black beads (provided by wet beading), such as the dry carbon black beads, are subsequently oxidized. The carbon black beads obtained after the wet beading generally refer to beads that are dried. Dry means that the wet beads are subjected to a drying step. The water content of the dry beads after wet beading can be up to 5 wt.-%, such as 4 wt.-%, such as 0.001 to 5 wt.-%, 0.01 to 4 wt.-%, 0.1 to 3 wt.-%. Preferably the wet beaded carbon black has a water content of 0.01 to 2 wt.-%. The weight % refers to the total weight of the wet beaded carbon black.

The obtained oxidized wet beaded carbon black has inter alia a high pellet crush strength and a low pellet attrition. At the same time, the volatiles can be controlled during the production without the risk to lose volatiles (i.e. decrease the degree of oxidation) during the drying process or beading process. In other words, a further advantage of the present invention is that the oxidized product is not exposed to an elevated temperature since the oxidation occurs after the wet beading (including the drying) of the carbon black and thus, the oxidation can be controlled more efficiently. Moreover, the bead properties are not only maintained, i.e. the beads are not destroyed/altered during the oxidation step, but the properties of the beads could even be improved.

Additionally, the wet beading of carbon black depends on the specific carbon black powder material so that the drying step varies for different carbon black powder materials. Accordingly, a process that requires a higher amount of energy for the drying results in a higher loss of volatiles on the surface of the oxidized wet beaded carbon black. The new and inventive process overcomes such a limitation so that a more versatile process is provided.

The oxidation in step (c) can be carried out in a screw conveyor comprising the reaction chamber mentioned in step (c) and at least one ozone inlet to supply ozone to the reaction chamber. The wet beaded carbon black obtained in step (a) can be supplied to the screw conveyor, particularly to the reaction chamber of the screw conveyor. The screw conveyor is further described below. However, the inventive process is not limited to a screw conveyor but can be carried out in any reactor, and particularly that is able to prevent the destruction of the beads during the oxidation. Nevertheless, a screw conveyor is particularly preferred since the wet beaded carbon black is not destroyed during the beading.

It is desired that the speed of the screw (screw of the screw conveyor) is 0.01 to 10 rpm, preferably 0.1 to rpm, more preferably 0.2 to 3 rpm, even more preferably 0.3 to 2.5 rpm and most preferably 0.4 to 1 rpm. Generally, the screw rotational speed is not limited to a specific value. The rotational speed of the screw can have an influence of the properties of the produced oxidized wet beaded carbon black. For instance, a low rotational speed of the screw results in a higher volatiles content of the produced oxidized wet beaded carbon black since the wet beaded carbon black is longer present in the reaction chamber. Accordingly, a lower rotational speed of the screw may require a lower supply of ozone (or ozone flow, such as set ozone flow) if the desired volatiles content should be constant. It is desired that the rotational speed of the screw is set to a value where no or only a minimal destruction of the beads is observed. The optimal rotational speed may depend on the specific wet beaded carbon black material to be oxidized. Accordingly, it is recommended to measure the optimal rotational speed of the screw of the specific screw conveyor as well as the wet beaded carbon black. The measured values can be stored in a look up table as a rotational speed n(t) and the set motor current Iₛₑₜ(t) that is required for the rotational speed n(t). As mentioned above, the rotational speed n(t) should be a rotational speed where no or only a minimal destruction of the beads is observed. Additionally, the required flow of the oxidation agent (such as ozone) can be determined and stored in the look up for the desired oxidized wet beaded carbon black. A user can increase or decrease the rotational speed of the screw or the ozone flow as required during the process.

The screw rotational speed has further an influence of the pellet crush strength, the pellet attrition, and the fines content as well as the destruction of the beads. A fast rotational speed of the screw result in a higher throughput of the process. During the oxidation step (c), at least 80%, preferably 90%, more preferably 95%, of the pellets should not be crushed.

The carbon black in step (a) is generally provided as a powder. Any kind of carbon black powder material can be used according to the invention, for instance, acetylene black, channel black, furnace black, lamp black and thermal black. Furnace black is particularly preferred. A crusher can further pulverize the carbon black powder before the wet beading.

The carbon black according to step (a) can have a statistical thickness surface area (STSA) determined according to ASTM D6556-17 in a range from 30 to 190 m²/g, preferably from 50 to 160 m²/g, more preferably 100 to 140 m²/g, and most preferably 110 to 120 m²/g, and a compressed oil absorption number (COAN) determined according to ASTM D3493-18 in a range from 55 to 150 mL/100 g, preferably from 80 to 120 mL/100 g, more preferably from 90 to 115 mL/100 g.

The carbon black according to step (a) can have a BET surface area determined according to ASTM D6556-17 in a range from 30 to 200 m²/g, preferably from 50 to 170 m²/g, more preferably 100 to 150 m²/g, and an oil absorption number (OAN) measured according to ASTM D2414-18 in a range from 60 to 180 mL/100 g, preferably from 85 to 140 mL/100 g, more preferably from 100 to 130 mL/100 g.

Generally, the BET surface area can be measured by nitrogen adsorption in accordance with ASTM D6556-17.

The carbon black according to step (a) can have a BET surface area determined according to ASTM D6556-17 in a range from 40 to 100 m²/g, preferably from 50 to 80 m²/g, more preferably 55 to 70 m²/g, and an oil absorption number (OAN) measured according to ASTM D2414-18 in a range from 150 to 450 mL/100 g, preferably from 200 to 320 mL/100 g, more preferably from 240 to 300 mL/100 g.

The carbon black according to step (a) can have a BET surface area determined according to ASTM D6556-17 in a range from 10 to 100 m²/g, preferably from 20 to 90 m²/g, more preferably 25 to 80 m²/g, and an oil absorption number (OAN) measured according to ASTM D2414-18 in a range from 20 to 180 mL/100 g, preferably from 30 to 160 mL/100 g, more preferably from 40 to 150 mL/100 g.

The carbon black according to step (a) can have a BET surface area determined according to ASTM D6556-17 in a range from 200 to 600 m²/g, preferably from 250 to 500 m²/g, more preferably 300 to 450 m²/g, and an oil absorption number (OAN) measured according to ASTM D2414-18 in a range from 50 to 200 mL/100 g, preferably from 60 to 120 mL/100 g, more preferably from 70 to 100 mL/100 g.

The carbon black according to step (a) can have a BET surface area determined according to ASTM D6556-17 in a range from 15 to 500 m²/g, preferably from 30 to 300 m²/g, more preferably from 40 to 250 m²/g, even more preferably from 50 to 200 m²/g, most preferably from 70 to 150 m²/g.

The carbon black according to step (a) can have an oil absorption number (OAN) measured according to ASTM D2414-18 in a range from 30 to 350 mL/100 g, preferably from 40 to 300 mL/100 g, more preferably from 50 to 150 mL/100 g, even more preferably from 100 to 290 mL/100 g, most preferably from 40 to 150 mL/100 g.

For the oxidation any oxidation agent can be used. According the inventive process is not limited to a specific oxidation agent. In step (c) ozone, H₂O₂ and/or NOx (such as HNO₃) can be used for the oxidation. Ozone is particularly preferred since ozone can be easily obtained from an ozone generator using air. Moreover, a reduced oxidation/corrosion of the equipment is observed by using of ozone instead of NOx. This is particularly useful for a screw conveyor comprising moving parts such as the screw. However, if specific functional groups are desired on the surface of the carbon black, a different oxidation agent can be used such as NOx.

High concentrations of ozone can be used in the reaction chamber for the oxidation. The concentration or amount of ozone in the reaction chamber depends on the desired degree of oxidation (amount of volatiles). The concentration of ozone should be the highest at the ozone inlets and decreases towards the outlet for the produced oxidized wet beaded carbon black. It is desired that the ozone completely reacts with the wet beaded carbon black. Thus, it is desired that substantially no ozone or no ozone is present at the outlet of the reaction chamber, or the amount of ozone is below 0.1 wt.-% of the gas present at the outlet of the reaction chamber. The ozone concentration or amount can be adjusted by the ozone flow into the reaction chamber. It is desired that 0.1 to 95 wt.-%, preferably 0.5 to 20 wt.-%, more preferably 1 to 15 wt.-%, even more preferably 1.5 to 15 wt.-%, most preferably 2 to 10 wt.-%, of the gas present in the reaction chamber is ozone and/or of the gas subjected to the reaction chamber via the ozone inlet is ozone. Usually 0.5 to 5 wt.-% of the gas present in the reaction chamber is ozone. Particularly, ozone enriched air is used for the oxidation step comprising the amount or concentration mentioned herein. The concentration of ozone in the reaction chamber or the concentration of ozone that is subjected to the reaction chamber via the ozone inlets can be 1 to 300 g/m³, such as 1 to 200 g/m³, 1 to 50 g/m³, 1 to 60 g/m³, 15 to 60 g/m³, 15 to 60 g/m³, or 15 to 50 g/m³. The ozone concentration or the amount of ozone in the reaction chamber can consider a concentration gradient in the reaction chamber. Thus, the overall ozone concentration or amount of ozone in the entire reaction chamber is generally considered. Accordingly, it is possible that the ozone concentration at the ozone inlet is above the aforementioned maximum values or below the above minimum values at the outlet as long as the overall concentration is according the aforementioned ranges. The ozone flow can be 100 to 50000 g/h, such as 300 to 5000 g/h, 300 to 30000 g/h, 500 to 10000 g/h, 800 to 5000 g/h, 5000 to 30000 g/h, or 1000 to 30000 g/h. The ozone flow can be adjusted as desired for the degree of oxidization. Moreover, the ozone flow depends on the size of the screw conveyor. If a large screw conveyor is intended to use, a higher ozone flow should be utilized. The ozone that is subjected to the reaction chamber via said ozone inlets can be derived from air or liquid oxygen.

Generally, the ozone concentration is adjusted/controlled in such a way that the volatile content measured at 950° C. is 1 to 25 wt.-%, such as 1.5 to 20 wt.-%, 1 to 10 wt.-%, 1.5 to 10 wt.-%, 1.5 to 20 wt.-%, 2 to 10 wt.-%, 2 to 15 wt.-%, 5 to 15 wt.-%, 2.5 to 10 wt.-%, 3 to 7 wt.-%, or 3.5 to 7 wt.-%. Accordingly, the ozone concentration in the reaction chamber should be adjusted/controlled so that the desired volatile content is achieved. For instance, the ozone flow into the reactor can be adjusted/controlled to adjust/control the ozone concentration. The ozone concentration should refer to the ozone concentration at which the wet beaded carbon black is treated. For example, the ozone concentration in the reactor or in the reactor chamber.

The volatile content at 950° C. can also adjusted/controlled by the air flow and the dwell time of the wet beaded carbon black. The dwell time of the wet beaded carbon black can be adjusted by the feed rate of the wet beaded carbon black and/or the screw rotational speed.

Generally, the air flow is adjusted/controlled in such a way that the volatile content measured at 950° C. is 1 to 25 wt.-%, such as 1.5 to 20 wt.-%, 1 to 10 wt.-%, 1.5 to 10 wt.-%, 1.5 to 20 wt.-%, 2 to 10 wt.-%, 2 to 15 wt.-%, 5 to 15 wt.-%, 2.5 to 10 wt.-%, 3 to 7 wt.-%, or 3.5 to 7 wt.-%. For instance, the air flow into a reaction chamber.

Generally, the dwell time of the wet beaded carbon black is adjusted/controlled in such a way that the volatile content measured at 950° C. is 1 to 25 wt.-%, such as 1.5 to 20 wt.-%, 1 to 10 wt.-%, 1.5 to 10 wt.-%, 1.5 to 20 wt.-%, 2 to 10 wt.-%, 2 to 15 wt.-%, 5 to 15 wt.-%, 2.5 to 10 wt.-%, 3 to 7 wt.-%, or 3.5 to 7 wt.-%. For instance, the dwell time of the wet beaded carbon black in a reaction chamber.

Generally, the screw rotational speed is adjusted/controlled in such a way that the volatile content measured at 950° C. is 1 to 25 wt.-%, such as 1.5 to 20 wt.-%, 1 to 10 wt.-%, 1.5 to 10 wt.-%, 1.5 to 20 wt.-%, 2 to 10 wt.-%, 2 to 15 wt.-%, 5 to 15 wt.-%, 2.5 to 10 wt.-%, 3 to 7 wt.-%, or 3.5 to 7 wt.-%. For instance, the screw rotational speed of a screw conveyor.

It is possible that the ozone concentration, the air flow, the dwell time of the wet beaded carbon black and/or the screw rotational speed, is (are) adjusted/controlled in such a way that the volatile content measured at 950° C. is 1 to 25 wt.-%, such as 1.5 to 20 wt.-%, 1 to 10 wt.-%, 1.5 to 10 wt.-%, 1.5 to 20 wt.-%, 2 to 10 wt.-%, 2 to 15 wt.-%, 5 to 15 wt.-%, 2.5 to 10 wt.-%, 3 to 7 wt.-%, or 3.5 to 7 wt.-%.

Volatiles at 950° C. can be measured using a thermogravimetric instrument of Fa. LECO Instrumente GmbH (TGA-701) according to the following protocol: Pans are dried at 650° C. for 30 min. The carbon black materials are stored in a desiccator equipped with desiccant prior to measurements. Baked-out pans are loaded in the instrument, tared and filled with between 0.5 g to 10 g carbon black material. Then, the oven of the TGA instrument loaded with the sample-filled pans is gradually heated up to 105° C. by automated software control and the samples are dried until a constant mass is achieved. Subsequently, the pans are closed by lids, the oven is purged with nitrogen (99.9 vol % grade) and heated up to 950° C. The oven temperature is kept at 950° C. for 7 min. The content of volatiles at 950° C. is calculated using the following equation:

$$Volatiles = \frac{m ( prior to heating ) - m ( after 7 minutes @ 950 ° C . )}{m ( prior to heating )} \cdot 100 \% .$$

The volatile content can also be measured according to DIN 53552:1977-09.

The weight ratio of the wet beaded carbon black (such as dry weight of the carbon black) to ozone for the oxidation in step (c) should be over 1, preferably 3 or more, more preferably 4 or more. Particularly, the weight ratio of the wet beaded carbon black to ozone for the oxidation in step (c) should be 1:1 to 15:1, preferably 1.1:1 to 13:1, more preferably 1.5:1 to 10:1, even more preferably 2:1 to 8:1, most preferably 3:1 to 6:1.

The temperature for the oxidation in step (c) is 10 to 60° C., preferably 20 to 50° C., more preferably 30 to 45° C. Particularly, the temperature in the reaction chamber is 10 to 60° C., preferably 20 to 50° C., more preferably 30 to 45° C. The temperature in the screw conveyor can be controlled by a liquid or fluid, such as water, attached to the screw conveyor or the barrel of the screw conveyor. Accordingly, the screw conveyor can comprise temperature control unit for cooling or heating. It is desired that the temperature in the reaction chamber or for the oxidation is controlled so that no loss of volatiles during the oxidation occurs. Generally, the oxidation of wet beaded carbon black is an exothermic reaction so that heat should be dissipated. This can be particularly relevant for a process in which a highly oxidated carbon black or a highly oxidated wet beaded carbon black is to be obtained. However, in a process in which a low oxidized carbon black is to be obtained, it can be beneficial if additional heat is transferred to the reaction chamber for the oxidation step.

The wet beading (b) comprises generally the following steps: (b1) treating the carbon black with water to obtain wet carbon black, (b2) beading the wet carbon black to obtain beaded carbon black comprising water, and (b3) drying the beaded carbon black to obtain wet beaded carbon black.

The water content of the wet beaded carbon black should be less than 10 wt.-%, more preferably less than 5 wt.-%, even more preferably 0.001 to 4 wt.-%, and most preferably 0.01 to 1 wt.-%. This means that after the aforementioned drying step, most of the water content is removed so that the oxidation is performed using already dried wet beaded carbon black. Thus, it is preferred that the oxidation is performed using dried wet beaded carbon black.

Wet beading is usually carried out in a “wet beading box” equipped with a multiplicity of agitator pins secured to a shaft extending longitudinally through the body and rotating a speed up to about 240 rpm depending on the type of carbon black powder to be treaded. The action of the pins causes the moist carbon black to form into beads or pellets which are subsequently dried in a dryer. However, every type of wet beading apparatus may be used for the wet beading.

The weight of water used for the beading is usually equal to the weight of the carbon black powder to be beaded. The range can be 5 wt.-% to 1000 wt.-%, based on the total weight of the carbon black. Preferably 20 to 200 wt.-%, more preferably 50 to 150 wt.-%, based on the total weight of the carbon black.

The water for the wet beading usually comprises a binder, preferably the binder comprises molasse, and/or lignosulfonates. Such binders are uniformly dispersed through the beads. A binder can increase the crushing strength and packing point of carbon black beads. The binder can be present in an amount of 0.01 to 1.00 wt.-%, preferably 0.05 to 0.9 wt.-%, more preferably 0.1 to 0.80 wt.-%, based on the total weight of the carbon black, particularly the carbon black for the wet beading. The weight ratio of the binder to the carbon black for the wet beading is from 1/10000 to 1/100, preferably 1 to 1/2000 to 1/110, more preferably 1/1000 to 1/125.

The pellet size (or beads size) of the wet beaded carbon black and/or the oxidized wet beaded carbon black can be 10 mm or less, preferably 5 mm or less, more preferably 3 mm or less. It is possible that at least 90 wt.-% of the wet beaded carbon black and/or the oxidized wet beaded carbon black have a pellet size of 0.1 to 20 mm, preferably 0.1 to 15 mm, more preferably 0.1 to 10 mm, most preferably 0.5 to 10 mm, based on the total weight of the wet beaded carbon black and/or the oxidized wet beaded carbon black. In other words, (a) 10 to 90 wt.-% of the oxidized wet beaded carbon black can have a pellet size of 0.1 to 10 mm, preferably 0.5 to 6 mm, more preferably 0.5 to 5 mm, (b) 30 to 90 wt.-% of the oxidized wet beaded carbon black (202) can have a pellet size of 0.1 to 10 mm, preferably 0.5 to 6 mm, more preferably 0.5 to 5 mm. (c) 50 to 90 wt.-% of the oxidized wet beaded carbon black (202) can have a pellet size of 0.1 to 10 mm, preferably 0.5 to 6 mm, more preferably 0.5 to 5 mm, or (d) 70 to 90 wt.-% of the oxidized wet beaded carbon black (202) can have a pellet size of 0.1 to 10 mm, preferably 0.5 to 6 mm, more preferably 0.5 to 5 mm.

The bulk density of the wet beaded carbon black is normally over 150 g/L, preferably 150 to 600 g/L, more preferably 300 to 500 g/L. The bulk density can be measured according to ASTM D1513-05.

The air flow to the reaction chamber should be 5 to 1000 Nm³/h, such as 5 to 200 Nm³/h, 10 to 150 Nm³/h, 15 to 100 Nm³/h, 20 to 50 Nm³/h, 10 to 600 Nm³/h, 15 to 300 Nm³/h, 10 to 600 Nm³/h, 100 to 800 Nm³/h, or 200 to 600 Nm³/h. The air flow generally depends on the set ozone flow. Moreover, the air flow depends on the size of the reaction chamber. A larger reaction chamber usually requires a higher air flow. The wet beaded carbon black feed to the reaction chamber can be 0.01 to 1000 g/s, such as 1 to 500 g/s, 100 to 600 g/s, 0.05 to 50 g/s, 0.08 to 20 g/s, or 0.08 to 5 g/s.

As mentioned above, the invention is directed to an oxidized wet beaded carbon black having a volatile content measured at 950° C. of 1 to 25 wt.-% and an average pellet crush strength of pellets with a diameter of from 0.71 to 1.0 mm of from 4 to 80 cN, preferably 5 to 40 cN, and more preferably 10 to 30 cN. The pellet crush strength, such as the average pellet crush strength, can be measured according to ASTM D5230-19. Particularly, the oxidized wet beaded carbon black has a volatile content measured at 950° C. of 1.5 to 20 wt.-%, such as 1 to 10 wt.-%, 1.5 to 10 wt.-%, 1.5 to 20 wt.-%, 2 to 10 wt.-%, 2 to 15 wt.-%, 2.5 to 10 wt.-%, 3 to 7 wt.-%, or 3.5 to 7 wt.-%. It is preferred that the volatile content measured at 950° C. of the wet beaded carbon black according to the invention is 2.2 to 25 wt.-%, preferably 2.2 to 20 wt.-%, more preferably 2.2 to 15 wt.-%, even more preferably 3 to 15 wt.-% and most preferably 3 to 10 wt.-%. It has been surprisingly found that an oxidized wet beaded carbon black could be produced that has a high content of volatile content measured at 950° C. and at the same time a high pellet crush strength if a wet beaded carbon black is produced that is subsequently oxidized, particularly by using a screw conveyer as the oxidation unit. Furthermore, the oxidized wet beaded carbon black can be beneficially used in a rubber composition to increase the properties of the resulting rubber product.

The oxidized wet beaded carbon black can have an average pellet crush strength of pellets with a diameter of 1.0 to 1.4 mm of from 4 to 80 cN, preferably 5 to 40 cN, and more preferably 10 to 30 cN. The oxidized wet beaded carbon black can have an average pellet crush strength of pellets with a diameter of 1.4 to 1.7 mm of from 3 to 80 cN, preferably 4 to 40 cN, and more preferably 5 to 30.

The pellet crush strength, such as the average pellet crush strength, can be measured according to ASTM D5230-19.

It is particularly desired that the average pellet crush strength of pellets with a diameter is from 0.71 to 1.0 mm is from 4 to 80 cN, preferably 5 to 40 cN, and more preferably 10 to 30 cN, and the average pellet crush strength of pellets with a diameter of 1.0 to 1.4 mm is from 4 to 80 cN, preferably 5 to 40 cN, and more preferably 10 to 30 cN, and the average pellet crush strength of pellets with a diameter of 1.4 to 1.7 mm is from 3 to 80 cN, preferably 4 to 40 cN, and more preferably 5 to 30.

It is particularly desired that the average 5 hardest pellets with a diameter of 0.71-1.0 mm has a pellet crush strength of 10 to 110 cN, preferably 12 to 80 cN, more preferably 15 to 60 cN, and most preferably 17 to 50 cN. The hardest pellet with a diameter of 0.71-1.0 mm should have a pellet crush strength of 10 to 110 cN, preferably 12 to 80 cN, more preferably 15 to 60 cN, and most preferably 17 to 50 cN. The average 5 hardest pellets with a diameter of 1.0-1.4 mm should have a pellet crush strength of 10 to 110 cN, preferably 12 to 80 cN, more preferably 15 to 60 cN, and most preferably 17 to 50 cN. The hardest pellet with a diameter of 1.0-1.4 mm should have a pellet crush strength of 10 to 110 cN, preferably 12 to 80 cN, more preferably 15 to 60 cN, and most preferably 17 to 50 cN.

The iodine adsorption number of the oxidized wet beaded carbon black should be 30 to 80 mg/g, preferably 40 to 70 mg/g, more preferably 45 to 65 mg/g. The iodine adsorption number can be measured according to ASTM D1510-17.

The oxidized wet beaded carbon black should have statistical thickness surface area (STSA) determined according to ASTM D6556-17 in a range from 15 to 500 m²/g, preferably from 20 to 400 m²/g, more preferably from 30 to 300 m²/g, even more preferably from 40 to 200 m²/g, most preferably from 50 to 150 m²/g. 39.

The fines content of the oxidized wet beaded carbon black may be 0.1 to 50%, preferably 1 to 10%, and more preferably 1 to 5%. The fines contend can be measured according to ASTM D1508-02. A low fines content is an indicator for avoiding the destruction of the bead/pellets during the oxidation step.

The pH-value of the oxidized wet beaded carbon black should be below 7, such as 2 to 6, 2 to 4, 2 to 3, preferably 2.4 to 2.9, more preferably 2.7 to 2.9. The pH-value can be measured according to ASTM D1512-15b, Test Method B—Sonic Slurry.

The pellet attrition should be below 6.5%, preferably 0.1 to 5%, more preferably 0.2 to 3%, and most preferably 0.5 to 2%. The pellet attrition can be measured according to ASTM D1508-02. A low pellet attrition is desired so that the transportation and mixing of the beads is improved. Additionally, a low pellet attrition prevents the destruction of the pellets during the transportation or handling.

The inventive process can be carried out in a screw conveyor for the production of oxidized wet beaded carbon black comprising a reaction chamber and at least one ozone inlet to supply ozone to the reaction chamber. Thus, the screw conveyor can be used for oxidizing wet beaded carbon black. It has been found that the destruction of carbon black beads can be beneficially avoided using a screw conveyor for the oxidization.

Furthermore, the screw conveyor can comprise means to generate ozone. The means to generate ozone should be in connection with the at least one ozone inlet.

The screw conveyor is usually tube containing a “spiral blade” coiled around a shaft. The screw conveyor is further modified to allow the oxidation of wet beaded carbon black. Accordingly, the screw conveyor comprises and at least one ozone inlet to supply ozone to the chamber of the screw conveyor. The chamber of the screw conveyor is thus a reaction chamber, where the oxidation agent, such as ozone, can oxidize the wet beaded carbon black.

Accordingly, the screw conveyor can comprise ozone in the reaction chamber, preferably 0.1 to 80 wt.-%, more preferably 0.5 to 20 wt.-%, most preferably 1 to 10 wt.-%, of the gas present in the reaction chamber is ozone. The ozone inlet further comprises means to control and/or determine the supply of ozone to the reaction chamber to adjust the concentration of ozone in the reaction chamber. Additionally, the reaction chamber can comprise wet beaded carbon black and/or oxidized wet beaded carbon black. In sum, the reaction chamber should comprise wet beaded carbon black, oxidized wet beaded carbon black as well as ozone, preferably in the aforementioned amount/concentration. The ozone inlets are preferably located at the bottom of the barrel of the screw conveyor.

The screw conveyor can comprise at least one temperature control unit for cooling or heating the reaction chamber. During the oxidation of the wet beaded carbon black, the temperature may increase. To avoid the risk of losing volatiles (decrease the degree of oxidization) the temperature of the reaction chamber can be controlled by the temperature control unit. However, in a process in which a low oxidized carbon black is to be obtained, it can be beneficial if additional heat is transferred to the reaction chamber for the oxidation step. It is preferred that temperature control units are attached on the outer surface of the reaction chamber or barrel.

The screw of the screw conveyor (conveyor screw) can be a conventional helical screw blade. The screw of the screw conveyor has a thread (or helical screw blade), said thread can have 2 to 100 windings, preferably 5 to 50 windings. The thread may have a continuous or a constant increasing/decreasing pitch. Generally, the screw comprises a shaft and a helical conveyor blade thereon. However, it is also possible that the screw is a shaftless helical conveyor blade. Thus, the blade can be directly driven by a motor. The screw conveyor can comprise a helical conveyor blade. The screw generally has at least one screw flight extending radially and helically from and along the shaft.

The screw can be configurated at least partly as a flight, preferably at least partly as a single flight, more preferably at least partly as a double flight, wherein the screw comprises at least one second helical conveyor blade (second flight) and if the screw is configurated at least partly as double flight ribbon, further comprises at least one first helical conveyor blade (first flight).

The screw conveyor or the helical conveyor blade can comprise at least one first helical conveyor blade and/or at least one second helical conveyor blade. The first and second helical conveyor blade can be configured in sequence and thus form a single thread. It is also desired that the first and second helical conveyor blade form a twin thread (or double-start thread, or double flight). For instance, the first and second helical conveyor blade can form a high-low thread, wherein the first helical conveyor blade is the low thread and the second helical conveyor blade is the high thread. Individual turns of said first conveyor blade can extend at least over a partial length of the shaft between subsequent individual turns of said second conveyor blade. If a twin thread is present, both threads do not have to start simultaneously.

The second helical conveyor blade can extend at least over a partial length of said shaft with a radial distance to said shaft thereby forming a circumferential clearance between said shaft and said second helical conveyor blade. A helical conveyor blade having the aforementioned clearance is generally called a flight ribbon. Thus, the screw can be configurated at least partly as a flight ribbon, preferably at least partly as a single flight ribbon, more preferably at least partly as a double flight ribbon.

The screw can be configurated at least partly as a flight ribbon, preferably at least partly as a single flight ribbon, more preferably at least partly as a double flight ribbon, wherein the screw comprises at least one second helical conveyor blade (second flight) and if the screw is configurated at least partly as double flight ribbon, further comprises at least one first helical conveyor blade (first flight).

The screw can be configurated as a flight ribbon, preferably a single flight ribbon, more preferably a double flight, wherein one flight comprises at least partly a flight ribbon, wherein the screw comprises at least one second helical conveyor blade (second flight) and if the screw is configurated double ribbon, further comprises at least one first helical conveyor blade (first flight), wherein the at least one second helical conveyor blade (second flight) is configurated at least partly as the flight ribbon.

It is particularly preferred that the screw can be configurated as a double flight, wherein the screw comprises at least one second helical conveyor blade (second flight) and at least one first helical conveyor blade (first flight), wherein the at least one second helical conveyor blade (second flight) is configurated at least partly as the flight ribbon (preferably as the second segment). It is preferred that the flight ribbon is present adjacent to the ozone inlets.

It is also preferred that the screw can be configurated as a flight, wherein the screw comprises at least one second helical conveyor blade (second flight), wherein the at least one second helical conveyor blade (second flight) is configurated at least partly as a flight ribbon (preferably as the second segment), preferably the at least one second helical conveyor blade (second flight) has three segments, wherein the first segment is a flight directly and continuously attached to the shaft, the second segment is the flight ribbon, and the third segment is a flight directly and continuously attached to the shaft. It is preferred that the flight ribbon is present adjacent to the ozone inlets. The second segment should be located between the first and second segment.

It is particularly preferred that the screw can be configurated as a double flight, wherein the screw comprises at least one second helical conveyor blade (second flight) and at least one first helical conveyor blade (first flight), wherein the at least one second helical conveyor blade (second flight) is configurated at least partly as a flight ribbon (preferably as the second segment), preferably the at least one second helical conveyor blade (second flight) has three segments, wherein the first segment is a flight directly and continuously attached to the shaft, the second segment is the flight ribbon, and the third segment is a flight directly and continuously attached to the shaft, preferably wherein the at least one first helical conveyor blade (first flight) is a flight directly and continuously attached to the shaft. It is preferred that the flight ribbon is present adjacent to the ozone inlets. The second segment should be located between the first and second segment.

A clearance between the shaft and the helical conveyor blade in a conventional screw conveyor would have the disadvantage that the ability of conveying material would be decreased. In other words, the main purpose of a conventional screw conveyor is the transportation of material, e.g. for overcoming a slope. However, the present screw conveyor can be not only used for conveying the material but also to oxidize the feed material. Such a blade with clearance between the shaft and the helical conveyor blade can be beneficially used for the oxidation. The oxidation agent can be better distributed through the reaction chamber and the wet beaded carbon black can be uniformly mixed. A uniform mixing during the oxidation allows an improved and uniform oxidation of the wet beaded carbon black.

It is particularly preferred that the second helical conveyor blade with a radial distance to said shaft thereby forming a circumferential clearance between said shaft and said second helical conveyor blade extend at least over a partial length of said shaft where the ozone inlets are located.

It is possible that the second helical conveyor blade comprises a first segment comprising a helical conveyor blade directly attached to the shaft, and a second segment comprising a helical conveyor blade extending at least over a partial length of said shaft, preferably where the ozone inlets are located, with a radial distance to said shaft thereby forming a circumferential clearance between said shaft and said second helical conveyor blade. Moreover, it is desired that the second helical conveyor blade comprises a first segment comprising a helical conveyor blade directly attached to the shaft, a second segment comprising a helical conveyor blade extending at least over a partial length of said shaft, preferably where the ozone inlets are located, with a radial distance to said shaft thereby forming a circumferential clearance between said shaft and said second helical conveyor blade, and a third segment comprising a helical conveyor blade directly attached to the shaft. It is preferred that the second helical conveyor blade comprises the segments in the following order, first segment, second segment and third segment. The first helical conveyor blade can form a second thread of the screw, wherein the diameter (or outer diameter) of the first helical conveyor blade is smaller than the diameter (outer diameter) of the second helical conveyor blade.

Said second conveyor blade can be attached at least over a partial length of said shaft to said shaft via spacer bars radially extending from said shaft, preferably via three or more bars. Particularly, the second conveyor blade with a radial distance to said shaft thereby forming a circumferential clearance between said shaft and said second helical conveyor blade can be attached at least over a partial length of said shaft to said shaft via spacer bars radially extending from said shaft, preferably via three or more bars. This means that the segment of the second conveyor blade having said clearance should be attached at least over a partial length of said shaft to said shaft via spacer bars radially extending from said shaft, preferably via three or more bars.

The radial distance to a shaft thereby forming a circumferential clearance between said shaft and the second helical conveyor blade should be 10 to 200 mm, preferably 20 to 150 mm, more preferably 30 to 100 mm, even more preferably 40 to 80 mm, and most preferably 45 to 70 mm.

A radial distance to a shaft thereby forming a circumferential clearance between said shaft and a helical conveyor blade clearance in a conventional screw conveyor would have the disadvantage that the ability of conveying material would be decreased. In other words, the main purpose of a conventional screw conveyor is the transportation of material, for instance overcoming a slope. However, the screw conveyor according to the invention is not only used for conveying the material but also to oxidize the feed material. Such a blade with said clearance can be beneficially used for the oxidation. The oxidation agent can be better distributed through the reaction chamber and the wet beaded carbon black can be uniformly mixed. A uniform mixing during the oxidation allows an improved and uniform oxidation of the wet beaded carbon black.

It is preferred that the first conveyor blade has a first outer diameter and said second conveyor blade has a second outer diameter and wherein preferably the first and second outer diameters differ from each other. Particularly said first outer diameter is smaller than said second outer diameter. A spacing (lead) of said second conveyor blade at least over a partial length of the shaft should be smaller than a spacing (lead) of said first conveyor blade.

The screw conveyor can comprise a drive and a driven screw, said extending within a barrel forming said reaction chamber, the screw comprising a shaft and at least one first helical conveyor blade. The drive should be configured to drive the driven screw.

Generally, the screw of the screw conveyor comprises a shaft and at least one first helical conveyor blade. Alternatively, or additional, the screw of the screw conveyor comprises a shaft and at least one second helical conveyor blade.

The screw of the screw conveyor and/or the reaction chamber may have a length of 0.1 to 100 m, such as 1 to 20 m, 5 to 15, 2 to 4 m 10 to 90 m, or 20 to 80 m. The volume of the reaction chamber can be 1 to 10000 L, such as 10 to 1000 L, 20 to 100 L, 2 to 50 L, 100 to 9000 L, or 500 to 5000 L. The volume of the reaction chamber can be chosen as desired for the process. A higher input of the wet beaded carbon black feed requires a lager reaction chamber. The screw conveyor can comprise a drive and a driven screw, said extending within a barrel forming said reaction chamber. The screw conveyor usually comprises an inlet for the wet beaded carbon black to the reaction chamber. Similarly, the screw conveyor usually comprises an outlet for the produced oxidized wet beaded carbon black, wherein the outlet is positioned at the opposite side of the reaction chamber with respect to the inlet. The inlet should be arranged on the top of the screw conveyor and the outlet should be arranged on the bottom of the screw conveyor.

The diameter of the screw can be 50 to 300 mm, preferably 60 to 250 mm, more preferably 70 to 200 mm, even more preferably 80 to 150 mm, and most preferably 90 to 130 mm. The diameter of the at least one first and/or at least one second helical conveyor blade can be 50 to 1000 mm, preferably 100 to 800 mm, more preferably 150 to 700 mm, even more preferably 200 to 600 mm, and most preferably 250 to 400 mm. The diameter of at least one first helical conveyor blade can be 25 to 500 mm, preferably 50 to 400 mm, more preferably 75 to 350 mm, even more preferably 100 to 300 mm, and most preferably 150 to 300 mm. The inner diameter of the barrel can be 50 to 3000 mm, such as 100 to 800 mm, 150 to 700 mm, 200 to 600 mm, 250 to 400 mm. 100 to 2000 mm, or 150 to 1000 mm, preferably the inner diameter of the barrel is higher than the diameter of the at least one first and/or at least one second helical conveyor blade. The inner diameter of the at least one second helical conveyor blade can be 40 to 900 mm, preferably 80 to 750 mm, more preferably 130 to 650 mm, even more preferably 180 to 550 mm, and most preferably 230 to 350 mm. The outer diameter of the at least one second helical conveyor blade should be 50 to 1000 mm, preferably 100 to 800 mm, more preferably 150 to 700 mm, even more preferably 200 to 600 mm, and most preferably 250 to 400 mm.

Generally, the respective size of the components of the screw conveyor should be chosen with respect to the size of the screw conveyor. A large screw conveyor usually comprises larger components and larger dimensions of the components. Thus, the size and dimensions of the specific components or parts of the screw conveyor are usually matched.

The gap between the helical conveyor blade and the inner surface of the reactor chamber can be 0 mm (or more than 0 mm) to 200 mm, preferably 1 mm to 100 mm, more preferably 2 mm to 80 mm, even more preferably 5 to 50 mm, and most preferably 10 to 40 mm.

The at least one first and/or at least one second helical conveyor blade can comprise at least one turner attached thereto on a surface facing opposite the conveying direction. The turner should be able to lift a part of the wet beaded carbon black material so that the mixing of the material is improved. This allows a uniform mixing of the material so that the oxidization is enhanced.

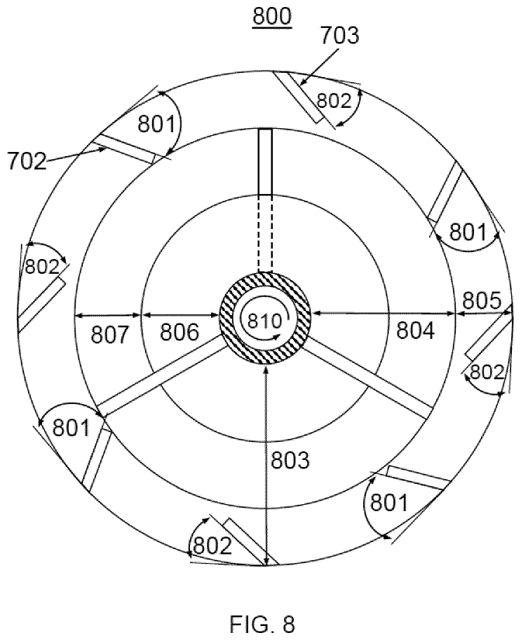

The at least one first and/or at least one second helical conveyor blade can comprise at least one first turner and at least one second turner. The at least one first and the at least one second turner can are alternating attached on at least one first and/or at least one second helical conveyor blade. The angle of the at least one first turner should be higher than the angle of the at least one second turner, wherein the turners extend in an angle relative to a tangent to the circumference of said second conveyor blade (shown in FIG. 8). The angle of the at least one first turner can be 30 to 100°, preferably 35 to 90°, more preferably 40 to 80°, even more preferably 50 to 70°, and most preferably 55 to 65°. The angle of the at least one second turner is 10 to 60°, preferably 15 to 55°, more preferably 20 to 50°, even more preferably 25 to 45°, and most preferably 35 to 45°, wherein the turners extend in an angle relative to a tangent to the circumference of said second conveyor blade.

The produced oxidized wet beaded carbon black can be implemented into a composition such as a rubber composition. Rubber compositions are widely applied for manufacturing numerous industrial products such as transmission and conveyor belts, tires or footwear. Carbon blacks are included in many polymer compositions, for example for modifying their color, mechanical, electrical, and/or processing properties. Carbon blacks are for instance commonly added to rubber compositions used to fabricate tires or components thereof to impart electrically dissipative properties to the insulating matrix. At the same time, carbon black additives affect the mechanical and elastic properties, such as stiffness, abrasion resistance and hysteresis, which affect to a great extent the performance of the resulting tire, e.g. in terms of its rolling resistance and durability.

Accordingly, a composition can be provided comprising (a) an elastomeric polymer material, and (b) an oxidized wet beaded carbon black, for instance the oxidized wet beaded carbon black according to the invention such as mentioned in the aspects or claims. It is particularly preferred that the composition comprises the oxidized wet beaded carbon black that is prepared according to the inventive process. Additionally, the preparation of the aforementioned composition is disclosed comprising the manufacturing of the oxidized wet beaded carbon black according to the invention and the addition of the oxidized wet beaded carbon black to a composition comprising an elastomeric polymer material. Thus, the composition, such as a rubber composition, is provided as described herein.

The term “composition” as used herein refers to a material composed of multiple constituent chemical species or components. An “elastomeric polymer material” is understood as a material essentially consisting of an elastomeric polymer. The term “polymer” is used herein in its common meaning in the art, referring to macromolecular compounds, i.e. compounds having a relatively high molecular mass (e.g. 500 Da or more), the structure of which comprises multiple repetition units (also referred to as “mers”) derived, actually or conceptually, from chemical species of relatively lower molecular mass. The term “elastomeric polymer” is used herein in its common meaning in the art, referring to a polymer which is elastic.

Particularly useful as elastomeric polymeric materials for the practice of this invention are elastomers such as rubber materials. The elastomeric polymer material (a) of the composition according to the present invention can comprise one or more than one rubber. The terms “rubber”, “rubber material” and “elastomer” may be used interchangeably throughout this description unless otherwise stated. Rubbers that can be used according to the present invention include those containing olefinic unsaturation, i.e. diene-based rubber materials, as well as non-diene-based rubber materials. The term “diene-based rubber materials” is intended to include both natural and synthetic rubbers or mixtures thereof. The elastomeric polymer material (a) can consist of synthetic rubber.

Accordingly, the invention also relates to articles and particularly tires made of or comprising the aforementioned composition according to the invention. The tire according to the present invention may comprise a tread, carcass, sidewall, inner liner, apex, shoulder, hump strip, chafer and/or a bead filler, wherein at least one of the foregoing is made of or comprises a composition according to the invention. Such tires include for example, without being limited thereto, truck tires, passenger tires, off-road tires, aircraft tires, agricultural tires, and earth-mover tires.

The article can be a cable sheath, a tube, a drive belt, a conveyor belt, a roll covering, a shoe sole, a hose, a sealing member, a profile, a damping element, a coating or a colored or printed article.

Moreover, the article can be a conveyor belt, wherein the conveyor belt is made of a composition comprises an elastomeric polymer material and the oxidized wet beaded carbon black, wherein the composition preferably comprises (a) from 60 to 95 phr of natural rubber and from 5 to 40 phr of synthetic rubber, preferably from 70 to 85 phr of natural rubber and from 15 to 30 phr of synthetic rubber, more preferably 80 phr of natural rubber and from 20 phr of synthetic rubber, wherein the synthetic rubber preferably comprises polybutadiene, more preferably consists of polybutadiene: and (b) from 30 to 70 phr of the oxidized wet beaded carbon black, preferably from 40 to 60 phr of the oxidized wet beaded carbon black, more preferably from 50 phr of the oxidized wet beaded carbon black.

Furthermore, the present invention relates to the use of the aforementioned composition according to the present invention for producing a tire, preferably a pneumatic tire, a tire tread, a belt, a belt reinforcement, a carcass, a carcass reinforcement, a sidewall, inner liner, apex, shoulder, hump strip, chafer, a bead filler, a cable sheath, a tube, a drive belt, a conveyor belt, a roll covering, a shoe sole, a hose, a sealing member, a profile, a damping element, a coating or a colored or printed article.

Furthermore, a process is disclosed for the preparation of a composition, preferably the composition according to the invention, comprising, mixing an elastomeric polymer material and an oxidized wet beaded carbon. Additionally, the use of the oxidized wet beaded carbon to prepare a rubber composition is disclosed.

The invention will now be described with reference to the accompanying figures which do not limit the scope and ambit of the invention. The description provided is purely by way of example and illustration. However, specific features exemplified in the figures can be used to further restrict the scope of the invention and claims.

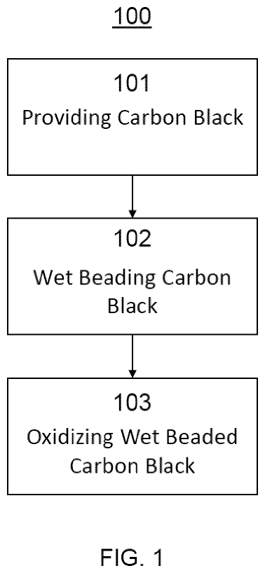

FIG. 1 relates to the inventive process for the production of oxidized wet beaded carbon black (202). First, the carbon black is provided (101), preferably as a powder. As mentioned above, the carbon black powder is preferably a furnace black. However, any kind of carbon black materials can be used according to the invention, including mixtures of carbon black materials. In the second step, the carbon black is wet beaded. Wet beading may include the subjection of the carbon black powder with water and optionally a binder. Subsequently, the mixture is beaded and dried to provide the wet beaded carbon black (102). The beads are then subjected to an oxidizing step (103) to obtain oxidized wet beaded carbon black (202). The oxidizing step is preferably carried out in a screw conveyor (200, 300) according to the invention. However, the particular means for the oxidation is not limited to the screw conveyor. Preferably ozone is used as oxidizing agent.

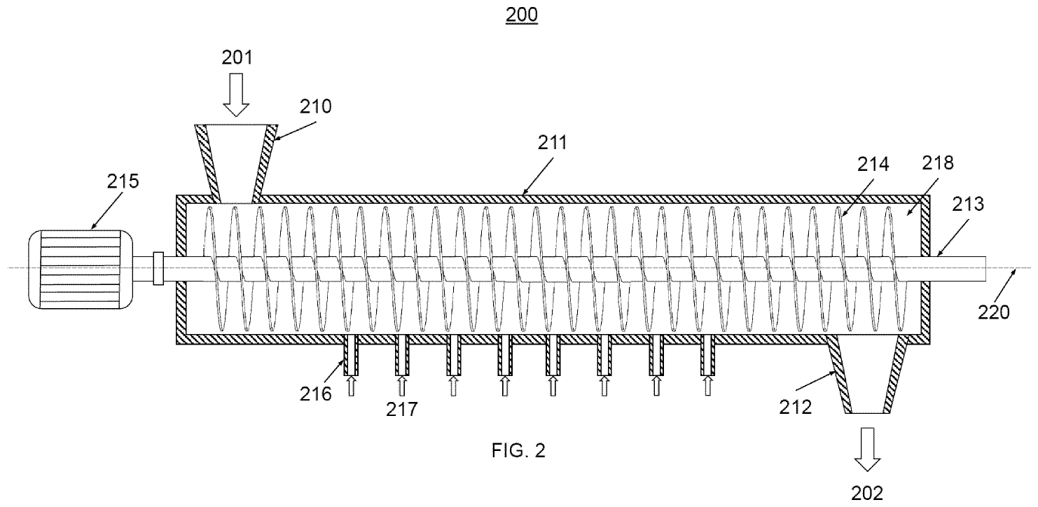

Referring to FIG. 2, an inner section of the screw conveyor (200) according to the invention is shown. The screw conveyor (200) comprises at least one first helical conveyor blade (214, 502) attached to a shaft (213) that is connected to an electric motor (215) that drives said screw. Alternatively, the helical conveyor blade shown in FIG. 2 is at least one second helical conveyor blade (501). The screw conveyor (200) further comprises a barrel (211) that defines the reaction chamber (218) or provides a barrier defining the reaction chamber (218). The screw conveyor (200) comprises an inlet (210) for the wet beaded carbon black (201) and an outlet (212) for the produced oxidized wet beaded carbon black (202). On the bottom of the screw conveyor (200) several ozone inlets (216) are attached to supply ozone (217) into the reaction chamber (218). The screw comprises at least one first helical conveyor blade (214) to transport feed material from the inlet in the direction to the outlet. If a second helical conveyor blade (501) that extends at least over a partial length of said shaft with a radial distance to said shaft (213) thereby forming a circumferential clearance (503) between said shaft (213) and said second helical conveyor blade (501) is present, it will be desired that said clearance (i.e. with a radial distance to said shaft (213) thereby forming a circumferential clearance (503) between said shaft (213) and said second helical conveyor blade (501)) is located over a partial length of said shaft where the ozone inlets are located. The longitudinal direction (220) of the screw is indicated in FIG. 1.

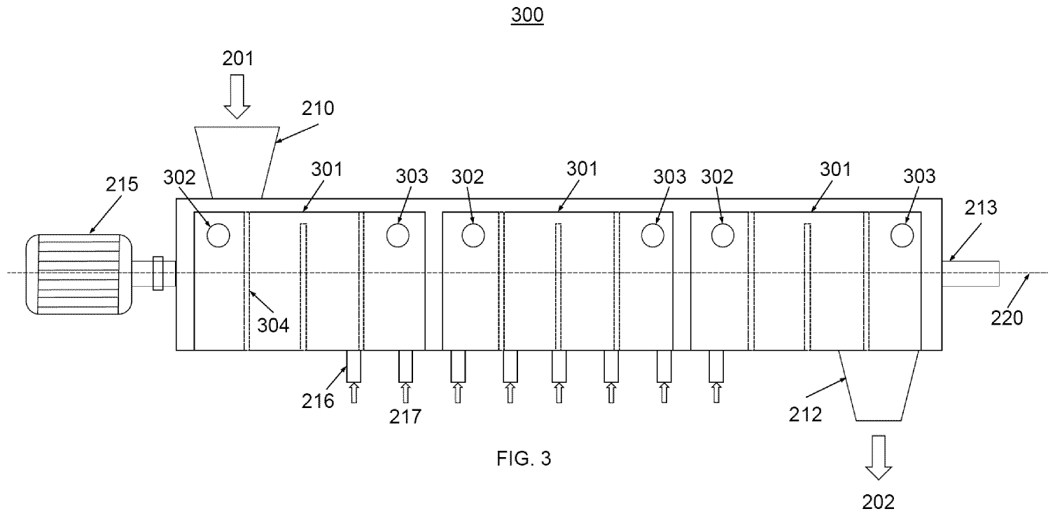

Referring to FIG. 3, an outer section of the screw conveyor (300) according to the invention is shown. In this view, three temperature control units (301) are visible that are attached on the outer wall of the screw conveyor (300), i.e. on the outer wall of the barrel (211). The temperature control units extend to the opposite side of the screw conveyor (300) that is not shown in this figure. Each temperature control unit (301) comprises an inlet (302) for a fluid, such as water, and an outlet (303) for the fluid, such as water. The inlet (301) and the outlet (302) can be interchanged. Furthermore, the barriers (304) are shown as dashed lines that indicate a flow passage of the fluid. Thus, each barrier has at least one opening for defining the flow passage so that the fluid can be transported from the inlet (302) to the outlet (303). Some openings are not shown in the figure since they are present on the opposite side of the temperature control units (301).

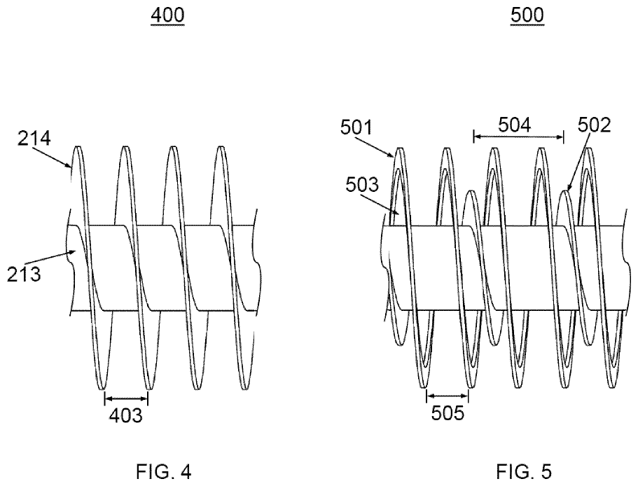

FIG. 4 shows a section of a screw (400) comprising at least one first helical conveyor blade (214, 502) attached to a shaft (213). In this view, a screw configured as single flight (at least partly) is shown. The at least one first helical conveyor blade (214, 502) are attached directly to the shaft (213) without a radial distance to said shaft (213) and thus, without forming a circumferential clearance (503) between said shaft (213) and said first helical conveyor blade (214, 502). Alternatively, the helical conveyor blade shown in FIG. 2 is at least one second helical conveyor blade (501). The spacing of said first conveyor blade (214, 502) is indicated in the figure. The spacing of the first conveyor blade is the lead. The spacing of a specific conveyor blade or the lead of a specific conveyor blade is the distance along the screw's axis that is covered by one complete rotation of said conveyor blade. If the screw comprises only one conveyor blade, the lead and the pitch are the same (single start thread). In FIG. 4 the flight directly and continuously attached to the shaft (without a clearance, not a flight ribbon).

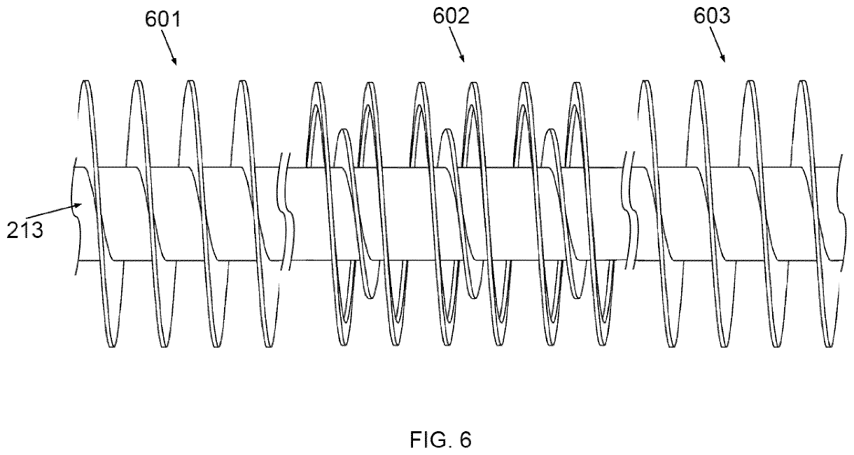

FIG. 5 reveals a section of a screw (500) comprising a shaft (213) and at least one first helical conveyor blade (502) and at least one second helical conveyor blade (501) extends at least over a partial length of said shaft with a radial distance to said shaft (213) thereby forming a circumferential clearance (503) between said shaft (213) and said second helical conveyor blade (501). Accordingly, the screw is designed as a twin thread (or double-start thread), wherein the first helical conveyor (502) is the low thread and the second helical conveyor is the high thread (501). This means that individual turns of said first conveyor blade (214, 502) at least over a partial length of the shaft extend between subsequent individual turns of said second conveyor blade (501). It is desired that this configuration is present where the ozone inlets are located. Thus, the described screw (500) is preferably arranged in the middle section of the screw, preferably where the inlets for the ozone (216) are located. Accordingly, the ozone (217) that is subjected via the inlets (216) can be easily distributed inside the reaction chamber (218) and an improved and uniform oxidation is achieved. It should be noted that the at least one second helical conveyor blade (501) extends at least over a partial length of said shaft with a radial distance to said shaft (213) thereby forming a circumferential clearance (503) between said shaft (213) and said second helical conveyor blade (501) can be attached to the screw via bars (spacer bars) that are not shown in the figure. The bars (spacer bars) can support the structure. However, any possible means to attach the at least one second helical conveyor blade (501) to the screw can be used. The spacing (504) or lead (504) of the at least one first helical conveyor blade (502) is indicated in FIG. 5. The spacing (505) or lead (505) of the at least one second helical conveyor blade (501) is indicated in FIG. 5. In this view, a screw configured as double flight (at least partly) that has a ribbon flight is shown. The ribbon flight is the at least one second the second helical conveyor (501).

Referring to FIG. 6, a screw (600) is shown that has different segments of helical conveyor blades (601, 602, 603). In this configuration the screw comprises a shaft (213) and at least one first helical conveyor blade (502) and at least one second helical conveyor blade (501) extends at least over a partial length of said shaft with a radial distance to said shaft (213) thereby forming a circumferential clearance (503) between said shaft (213) and said second helical conveyor blade (501). The screw is designed as a twin thread (or double-start thread), wherein the first helical conveyor (502) is the low thread and the second helical conveyor is the high thread (501). Accordingly, the second helical conveyor blade (501) extends only partly over a length of said shaft with a radial distance to said shaft (213) thereby forming a circumferential clearance (503) between said shaft (213) and said second helical conveyor blade (501). This part is indicated as segment (602). Thus, the second helical conveyor blade (501) in segments (601) and (603) are directly attaches to the shaft (213). A smooth transition of a segment of the second helical conveyor blade (501) directly connected to the shaft (213) to a segment that extends at least over a partial length of said shaft with a radial distance to said shaft (213) thereby forming a circumferential clearance (503) between said shaft (213) and said second helical conveyor blade (501) is generally formed.

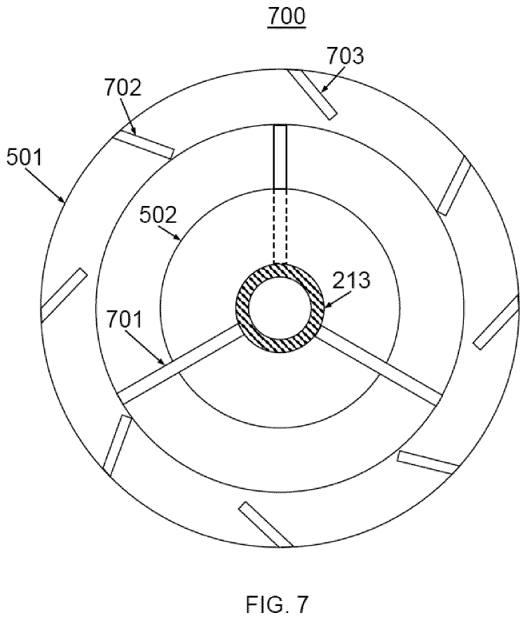

FIG. 7 and FIG. 8 reveal a cross section of a screw comprising a shaft (213), at least one first helical conveyor blade (502), at least one second helical conveyor blade (501) extends at least over a partial length of said shaft with a radial distance to said shaft (213) thereby forming a circumferential clearance (503) between said shaft (213) and said second helical conveyor blade (501) as well as turners (702, 703). The at least one second helical conveyor blade (501) extends at least over a partial length of said shaft with a radial distance to said shaft (213) thereby forming a circumferential clearance (503) between said shaft (213) and said second helical conveyor blade (501) are attached to the screw (213) via spacer bars (701). The number 502 indicates the at least one first helical conveyor blade (502) has a lower diameter. The respective diameters of the respective helical conveyor blades as well as said clearance (503) is indicated in FIG. 8. The inner diameter (804) of the at least one second helical conveyor blade (501) extends at least over a partial length of said shaft with a radial distance to said shaft (213) thereby forming a circumferential clearance (503) between said shaft (213) and said second helical conveyor blade (501) defines at the same time said clearance (503) between said second helical conveyor blade (501) and the shaft (213). It should be noted that the diameters mentioned herein refer to a diameter of the helical conveyor blades considering the cross-section as shown in e.g. FIG. 7. Furthermore, the outer diameter (803) of at least one second helical conveyor blade (501) extends at least over a partial length of said shaft with a radial distance to said shaft (213) thereby forming a circumferential clearance (503) between said shaft (213) and said second helical conveyor blade (501), the distance (807) between the at least one first helical conveyor blade (502) and the at least one second helical conveyor blade (501), the diameter (806) of the at least one first helical conveyor blade (502), as well as the distance (805) between the inner diameter and the outer diameter of the at least one second helical conveyor blade (501) is indicated in FIG. 8. As can be seen from FIG. 8, the turners (702, 703) are attached to the at least one second helical conveyor blade (501 in a specific angle (801, 802). The respective angle is the angle at which the turners extend in an angle relative to a tangent to the circumference of said second conveyor blade, particularly as indicated in FIG. 8. As mentioned above, the turners (702, 703) can also be attached to the at least one first helical conveyor blade (214, 502).

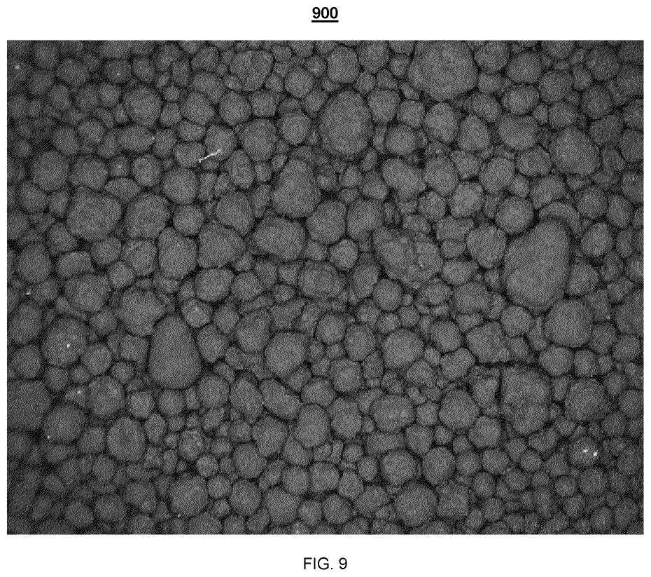

FIG. 9 shows oxidized wet beaded carbon black prepared according to the invention. As can be seen from the image, it is possible to oxidize wet beaded carbon black without destroying the beads.

### EXAMPLES

### Example 1: Production of Oxidized Wet Beaded Carbon Black According to the Invention

The carbon black powder used for the production of the oxidized wet beaded carbon black in Examples A to I (Ex. A to I) is N234.

In Examples A to H, the carbon black powder is wet beaded by subjecting water to the carbon black powder, beading the wet carbon black powder and subsequently drying the resulting wet beaded carbon black.

The wet beaded carbon black is then subjected to a screw conveyer for the oxidization. Ozone is supplied to the reaction chamber of the screw conveyer to oxidize the wet beaded carbon black. The settings and the results of the production of the oxidized wet beaded carbon black are indicated in table 1. The ozone flow indicates the target ozone flow in the reaction chamber. The reaction chamber of the screw conveyor is cooled with water.

In Comparative Example I (Comp. Ex. I) the carbon black powder is first oxidized and then dry beaded to avoid reducing the volatiles of the carbon black beads.

TABLE 1
Production of oxidized wet beaded carbon black.

| | | | | | | | | | Comp. |
|---|---|---|---|---|---|---|---|---|---|
| | Ex. A | Ex. B | Ex. C | Ex. D | Ex. E | Ex. F | Ex. G | Ex. H | Ex. I |
| Screw | 3 | 0.5 | 3 | 0.5 | 3 | 0.5 | 3 | 0.5 | |
| rotational | | | | | | | | | |
| speed [rpm] | | | | | | | | | |
| ozone flow | 1500 | 1500 | 1500 | 1500 | 1500 | 1500 | 1500 | 1500 | |
| [g/h] | | | | | | | | | |
| Air flow | 30 | 30 | 30 | 30 | 30 | 30 | 30 | 30 | |
| [Nm³/h] | | | | | | | | | |
| Carbon black | 0.1 | 0.1 | 0.1 | 0.1 | 0.1 | 0.1 | 0.1 | 0.1 | |
| feed [g/s] | | | | | | | | | |
| CB:O3¹⁰ | 4:1 | 4:1 | 4:1 | 4:1 | 4:1 | 4:1 | 4:1 | 4:1 | |
| ozone | 50 | 50 | 50 | 50 | 50 | 50 | 50 | 50 | |
| concentration | | | | | | | | | |
| [g/Nm³] | | | | | | | | | |
| Average pellet | 10.1 | 11.8 | 9.4 | 11.7 | 7.7 | 10.5 | 16.3 | 16.4 | 4.3 |
| crush strength | | | | | | | | | |
| 0.71-1.0 mm | | | | | | | | | |
| [cN]¹ | | | | | | | | | |
| Average 5 | 15.5 | 19.0 | 15.6 | 19.1 | 11.1 | 14.5 | 25.7 | 27.9 | 5.9 |
| hardest pellets | | | | | | | | | |
| 0.71-1.0 mm | | | | | | | | | |
| [cN]¹ | | | | | | | | | |
| Hardest Pellet | 16.9 | 21.6 | 19.8 | 26.0 | 11.9 | 17.4 | 32.1 | 39.3 | 6.4 |
| 0.71-1.0 mm | | | | | | | | | |
| [cN]¹ | | | | | | | | | |
| Average pellet | 12.4 | 17.8 | 11.5 | 13.9 | 14.9 | 13.7 | 15.5 | 19.6 | 7.8 |
| crush strength | | | | | | | | | |
| 1.0-1.4 mm | | | | | | | | | |
| [cN]¹ | | | | | | | | | |
| Average 5 | 23.9 | 31.0 | 19.3 | 22.3 | 21.1 | 24.3 | 24.6 | 31.0 | 9.9 |
| hardest pellets | | | | | | | | | |
| 1.0-1.4 mm | | | | | | | | | |
| [cN]¹ | | | | | | | | | |
| Hardest Pellet | 32.1 | 36.1 | 21.2 | 34.4 | 24.5 | 30.0 | 33.3 | 33.9 | 13.0 |
| 1.0-1.4 mm | | | | | | | | | |
| [cN]¹ | | | | | | | | | |
| Fines content² | 6.5 | 15.1 | 6.4 | 9.0 | 9.1 | 12.5 | 5.5 | 6.3 | 10.2 |
| [%] | | | | | | | | | |
| Volatiles³ [%] | 6.68 | 7.25 | 6.45 | 7.05 | 6.17 | 7.09 | 5.34 | 6.58 | 6.8 |
| BET surface | 131.8 | 133.0 | 132.2 | 133.5 | 129.2 | 130.5 | 128.0 | 129.8 | 125.6 |
| area⁴ [m²/g] | | | | | | | | | |
| STSA surface | 116.5 | 115.0 | 117.5 | 116.4 | 116.1 | 114.9 | 116.7 | 115.8 | 109.8 |
| area⁵ [m²/g] | | | | | | | | | |
| CTAB, | 119.8 | 118.3 | 120.8 | 119.6 | 119.4 | 118.2 | 120.0 | 119.1 | 113.0 |
| calculated | | | | | | | | | |
| [m²/g] | | | | | | | | | |
| Iodine | 49.5 | 41.0 | 54.9 | 45.4 | 55.1 | 46.2 | 62.9 | 53.6 | 46.5 |
| adsorption | | | | | | | | | |
| number⁷ | | | | | | | | | |
| [mg/g] | | | | | | | | | |
| Pellet | 0.8 | 1.0 | 0.6 | 1.1 | 0.8 | 1.0 | 0.6 | 0.9 | 6.7 |
| attrition⁸ [%] | | | | | | | | | |
| pH-value⁹ | 2.55 | 2.52 | 2.60 | 2.49 | 2.70 | 2.53 | 2.89 | 2.86 | 2.89 |
| OAN, Oil | 125.0 | 127.8 | 122.6 | 122.2 | 129.0 | 130.4 | 122.4 | 123.0 | 140.8 |
| absorption | | | | | | | | | |
| number¹⁰ | | | | | | | | | |
| [ml/100 g] | | | | | | | | | |

¹The pellet crush strength is measured according to ASTM D5230-19
²Fines contend measured according to ASTM D1508-02;
³Volatiles are measured at 950° C. for 7 min as described below;
⁴BET surface area is measured according to ASTM D6556-17;
⁵STSA surface area is measured according to ASTM D6556-17;
⁶Iodine adsorption number is measured according to ASTM D1510-17;
⁷Pellet attrition is measured according to ASTM D1508-02;
⁸pH-value is measured according to ASTM D1512-15b, Test Method B - Sonic Slurry;
⁹Oil absorption number is measured according to ASTM D2414-18;
¹⁰weight ratio of carbon black to ozone.

Volatiles at 950° C. were measured using a thermogravimetric instrument of Fa. LECO Instrumente GmbH (TGA-701) according to the following protocol: Pans were dried at 650° C. for 30 min. The carbon black materials were stored in a desiccator equipped with desiccant prior to measurements. Baked-out pans were loaded in the instrument, tared and filled with between 0.5 g to 10 g carbon black material. Then, the oven of the TGA instrument loaded with the sample-filled pans was gradually heated up to 105° C. by automated software control and the samples were dried until a constant mass was achieved. Subsequently, the pans were closed by lids, the oven was purged with nitrogen (99.9 vol % grade) and heated up to 950° C. The oven temperature was kept at 950° C. for 7 min. The content of volatiles at 950° C. was calculated using the following equation:

$$Volatiles = \frac{m ( prior to heating ) - m ( after 7 minutes @ 950 ° C . )}{m ( prior to heating )} \cdot 100 \% .$$

The produced oxidized wet beaded carbon black has a remarkable pellet crush strength compared to the beads obtained in Comparative Example I. This indicated that the beads are not destroyed during the oxidation treatment in a screw conveyor. The pellet crush strength is particularly high by using a low screw rotational speed such as 0.5 rpm instead of 3 rpm. On the other hand, the fines content is lower by using a higher screw rotational speed. The BET, STSA and CTAB surface area of the produced oxidized wet beaded carbon black is higher compared to palletized carbon black according to the Comp. Ex. I. Furthermore, the pellet attrition and the OAN is improved compared to palletized carbon black according to the Comp. Ex. I. FIG. 11 reveals the oxidized wet beaded carbon black produced according to Example A.

### Example 2: The Performance of Oxidized Wet Beaded Carbon Black in a Rubber Composition

The performance of the oxidized wet beaded carbon black in a composition comprising an elastomeric polymer material for the production of a rubber product is compared to beaded carbon black and oxidized carbon black powder. In Examples J and K the properties of rubber products produced from said compositions are measured several times and the values indicated in the respective tables refer to the average of the measurements.

As can be seen from the tables below, the loss factor tan δ is lower and therefore improved by using the oxidized wet beaded carbon black. Furthermore, the dynamic modulus is higher compared to carbon black which is first oxidized and dry beaded afterwards. Accordingly, the oxidized wet beaded carbon black can be beneficially used in a rubber composition to increase the properties of the resulting rubber product. The preparation of the compositions and the produced article can be seen below.

TABLE
Test formulations

| | | Composition | Composition | Composition |
|---|---|---|---|---|
| | Unit | 1 | 2 | 3 |
| Natural Rubber | phr | 100 | 100 | 100 |
| Wet beaded | phr | 55 | | |
| carbon black (not | | | | |
| oxidized) | | | | |
| Oxidized dry | phr | | 55 | |
| beaded carbon | | | | |
| black | | | | |
| Oxidized wet | phr | | | 55 |
| beaded carbon | | | | |
| black | | | | |
| ZnO | phr | 3 | 3 | 3 |
| Stearic Acid | phr | 3 | 3 | 3 |
| Sulfur | phr | 1.5 | 1.5 | 1.5 |
| Rhenogran DPG- | phr | 1.5 | 1.5 | 1.5 |
| 80 ¹ | | | | |
| Rhenogran | phr | 1.7 | 1.7 | 1.7 |
| TBBS-80 ² | | | | |

¹ Accelerator, commercially available from Rhein Chemie Additives
² Accelerator, commercially available from Rhein Chemie Additives

The compositions were prepared by standard rubber mixing procedures by applying three mixing steps. Each mixing step consisted of mixing in an internal mixer GK1.5E with intermeshing rotor geometry followed by mixing on an open two-roll mill.

In the first step natural rubber was milled in the internal mixer for 30 s. Then half of the CB, ZnO and stearic acid was added and mixed for 1:15 min. After that the ram was lifted and cleaned and the other half of the carbon black was added and mixed for 1:15 min when the ram was lifted and cleaned again. After in total 4 min of mixing the compound was transferred on the open mill. The chamber temperature was 60° C. and the rotor speed was 45 rpm during the whole first mixing step. It was secured that the batch temperature didn't exceed 160° C.

After the compound was stored for more than 16 h the compound was mixed without addition of chemicals for 6 min in which the mixing chamber had a temperature of 60° C. and the rotor speed was 48 rpm. Subsequently, the compound was transferred to the open mill. It was secured that the batch temperature didn't exceed 160° C.

After another storage time of minimum 16 h sulfur, TBBS-80 and DPG-80 were added to the composition while the internal mixer was operated with a chamber temperature of 40° C. and a rotor speed of 33 rpm. The drop temperature was between 80° C. and 110° C. Again, the mixing stage was finalized by mixing on the open mill where sheets were formed

The specimen, i.e. article, for the dynamic-mechanical analysis were cured for 13 min at 150° C.

### Example J

| | Wet beaded | Oxidized | Oxidized |
|---|---|---|---|
| | carbon black | dry beaded | wet beaded |
| | (not | carbon | carbon |
| | oxidized) | black | black |
| Frequency [Hz] | 16 | 16 | 16 |
| Temperature [° C.] | 60 | 60 | 60 |
| Preforce [N] | 50 | 50 | 50 |
| Dynamic deformation [N] | 25 | 25 | 25 |
| Dynamic modulus [MPa] | 9.6 | 9.075 | 9.29 |
| Loss factor tanδ | 0.184 | 0.127 | 0.125 |

### Example K

| | Wet beaded | Oxidized | Oxidized |
|---|---|---|---|
| | carbon black | dry beaded | wet beaded |
| | (not | carbon | carbon |
| | oxidized) | black | black |
| Frequency [Hz] | 16 | 16 | 16 |
| Temperature [° C.] | 60 | 60 | 60 |
| Static deformation [mm] | 1 | 1 | 1 |
| Dynamic deformation | 0.5 | 0.5 | 0.5 |
| [mm] | | | |
| Dynamic modulus [MPa] | 8.66 | 8.26 | 8.39 |
| Loss factor tanδ | 0.182 | 0.132 | 0.130 |

The above-mentioned values and the loss factor tan(d) were measured according to DIN 53 513 in strain-controlled mode (1±0.5 mm) or force-controlled mode (50 N±25 N) on a cylindrical specimen (10 mm in height and 10 mm in diameter) at 60° C. with a frequency of 16 Hz.

### ASPECTS OF THE INVENTION

1. A process (100) for the production of oxidized wet beaded carbon black (202), preferably oxidized wet beaded carbon black (202) according to any one of aspects 23 to 29, comprising the following steps:
(a) providing carbon black (101),
(b) wet beading the carbon black (102) obtained in step (a) to obtain wet beaded carbon black, and
(c) oxidizing the wet beaded carbon black (103) obtained in step (b) in a reaction chamber (218) to obtain oxidized wet beaded carbon black (202), preferably oxidized wet beaded carbon black (202) according to any one of aspects 23 to 29.

2. The process (100) according to aspect 1, wherein step (c) uses ozone (217), H₂O₂ and/or NOx for the oxidation, preferably ozone (217).

3. The process (100) according to aspects 1 or 2, wherein 0.1 to 95 wt.-%, preferably 0.5 to 20 wt.-%, more preferably 1 to 15 wt.-%, even more preferably 1.5 to 15 wt.-%, most preferably 2 to 10 wt.-%, of the gas present in the reaction chamber (218) is ozone (217), and/or the concentration of ozone (217) in the reaction chamber (218) is 1 to 300 g/m³, such as 1 to 200 g/m³, 1 to 50 g/m³, 1 to 60 g/m³, 15 to 60 g/m³, 15 to 60 g/m³, or 15 to 50 g/m³.

4. The process (100) according to any one of the preceding aspects, wherein the ozone (217) concentration is adjusted/controlled in such a way that the volatile content measured at 950° C. is 1 to 25 wt.-%, such as 1.5 to 20 wt.-%, 1 to 10 wt.-%, 1.5 to 10 wt.-%, 1.5 to 20 wt.-%, 2 to 10 wt.-%, 2 to 15 wt.-%, 2.5 to 10 wt.-%, 3 to 7 wt.-%, or 3.5 to 7 wt.-%.

5. The process (100) according to any one of preceding aspects wherein the carbon black in step (a) (101) is provided as a powder.

6. The process (100) according to any one of the preceding aspects, wherein the carbon black in step (a) (101) has a BET surface area determined according to ASTM D6556-17 in a range from 15 to 500 m²/g, preferably from 30 to 300 m²/g, more preferably from 40 to 250 m²/g, even more preferably from 50 to 200 m²/g, most preferably from 70 to 150 m²/g.

7. The process (100) according to any one of the preceding aspects, wherein the carbon black in step (a) has an oil absorption number (OAN) measured according to ASTM D2414-18 in a range from 30 to 350 mL/100 g, preferably from 40 to 300 mL/100 g, more preferably from 50 to 150 mL/100 g, even more preferably from 100 to 290 mL/100 g, most preferably from 40 to 150 mL/100 g.

8. The process (100) according to any one of the preceding aspects, wherein the carbon black according to step (a) has
(a) a BET surface area determined according to ASTM D6556-17 in a range from 40 to 100 m²/g, preferably from 50 to 80 m²/g, more preferably 55 to 70 m²/g, and an oil absorption number (OAN) measured according to ASTM D2414-18 in a range from 150 to 350 mL/100 g, preferably from 200 to 320 mL/100 g, more preferably from 240 to 300 mL/100 g,
(b) a BET surface area determined according to ASTM D6556-17 in a range from 10 to 100 m²/g, preferably from 20 to 90 m²/g, more preferably 25 to 80 m²/g, and an oil absorption number (OAN) measured according to ASTM D2414-18 in a range from 20 to 180 mL/100 g, preferably from 30 to 160 mL/100 g, more preferably from 40 to 150 mL/100 g, and/or
(c) a BET surface area determined according to ASTM D6556-17 in a range from 200 to 600 m²/g, preferably from 250 to 500 m²/g, more preferably 300 to 450 m²/g, and an oil absorption number (OAN) measured according to ASTM D2414-18 in a range from 50 to 150 mL/100 g, preferably from 60 to 120 mL/100 g, more preferably from 70 to 100 mL/100 g.

9. The process (100) according to any one of the preceding aspects, wherein the oxidation in step (c) is carried out in a screw conveyor (200, 300) comprising the reaction chamber (218) mentioned in step (c) and at least one ozone inlet (216) to supply ozone (217) to the reaction chamber (218), preferably the speed of the screw is 0.01 to 10 rpm, preferably 0.1 to 5 rpm, more preferably 0.2 to 3 rpm, even more preferably 0.3 to 2.5 rpm and most preferably 0.4 to 1 rpm.

10. The process (100) according to aspect 9, wherein the wet beaded carbon black (201) obtained in step (a) (101) is supplied to the screw conveyor (200, 300), particularly to the reaction chamber (218) of the screw conveyor (200, 300).

11. The process (100) according to any one of the preceding aspects, wherein the weight ratio of the wet beaded carbon black (201) (such as the dry weight of the carbon black) to ozone (217) for the oxidation in step (c) (103) is 1:1 to 15:1, preferably 1.1:1 to 13:1, more preferably 1.5:1 to 10:1, even more preferably 2:1 to 8:1, most preferably 3:1 to 6:1, and/or the weight ratio of the wet beaded carbon black (201) (such as the dry weight of the carbon black) to ozone (217) for the oxidation in step (c) (103) is over 1, preferably 3 or more, more preferably 4 or more.

12. The process (100) according to any one of the preceding aspects, wherein the temperature for the oxidation in step (c) (103) is 10 to 60° C., preferably 20 to 50° C., more preferably 30 to 45° C.

13. The process (100) according to any one of the preceding aspects, wherein the temperature in the reaction chamber is (103) is 10 to 60° C., preferably 20 to 50° C., more preferably 30 to 45° C.

14. The process (100) according to any one of the preceding aspects, wherein the bulk density of the wet beaded carbon black (201) is over 150 g/L, preferably 150 to 600 g/L, more preferably 300 to 500 g/L.

15. The process (100) according to any one of the preceding aspects, wherein the wet beading (b) comprises:
(b1) treating the carbon black with water to obtain wet carbon black,
(b2) beading the wet carbon black to obtain beaded carbon black comprising water, and
(b3) drying the beaded carbon black to obtain wet beaded carbon black (201), wherein preferably the water content of the wet beaded carbon black (201) is less than 10 wt.-%, more preferably less than 5 wt.-%, and most preferably 0.01 to 1 wt.-%.

16. The process (100) according to aspect 15, wherein the water comprises a binder, preferably the binder comprises molasse, and/or lignosulfonates.

17. The process (100) according to any one of aspects 15 or 16, wherein the binder is present in an amount of 0.01 to 1.00 wt.-%, preferably 0.05 to 0.9 wt.-%, more preferably 0.1 to 0.80 wt.-%, based on the total weight of the water.

18. The process (100) according to any one of aspects 15 to 17, wherein the amount of water for treating the carbon black is 5 to 1000 wt.-%, preferably 20 to 200 wt.-%, more preferably 50 to 150 wt.-%, based on the total weight of the carbon black.

19. The process (100) according to any one of the preceding aspects, wherein the pellet size of the wet beaded carbon black (201) and/or the oxidized wet beaded carbon black (202) is 10 mm or less, preferably 5 mm or less, more preferably 3 mm or less.

20. The process (100) according to any one of the preceding aspects, wherein
(a) 10 to 90 wt.-% of the oxidized wet beaded carbon black (202) has a pellet size of 0.1 to 10 mm, preferably 0.5 to 6 mm, more preferably 0.5 to 5 mm,
(b) 30 to 90 wt.-% of the oxidized wet beaded carbon black (202) has a pellet size of 0.1 to 10 mm, preferably 0.5 to 6 mm, more preferably 0.5 to 5 mm,
(c) 50 to 90 wt.-% of the oxidized wet beaded carbon black (202) has a pellet size of 0.1 to 10 mm, preferably 0.5 to 6 mm, more preferably 0.5 to 5 mm, or
(d) 70 to 90 wt.-% of the oxidized wet beaded carbon black (202) has a pellet size of 0.1 to 10 mm, preferably 0.5 to 6 mm, more preferably 0.5 to 5 mm.

21. The process (100) according to any one of the preceding aspects, wherein at least 80%, preferably 90%, more preferably 95%, of the pellets are not crushed during the oxidation step (c) (103).

22. Oxidized wet beaded carbon black (202) obtained according to any one of the preceding aspects.

23. Oxidized wet beaded carbon black (202) having a volatile content measured at 950° C. of 1 to 25 wt.-% and an average pellet crush strength of pellets with a diameter of from 0.71 to 1.0 mm of from 4 to 80 cN, preferably 5 to 40 cN, and more preferably 10 to 30 cN.

24 The oxidized wet beaded carbon black (202) according to aspect 23, wherein the oxidized wet beaded carbon black (202) has an average pellet crush strength of pellets with a diameter of 1.0 to 1.4 mm of 4 to 80 cN, preferably 5 to 40 cN, and more preferably 10 to 30 cN, and/or wherein the oxidized wet beaded carbon black has an average pellet crush strength of pellets with a diameter of 1.4 to 1.7 mm of from 3 to 80 cN, preferably 4 to 40 cN, and more preferably 5 to 30 cN.

25. The oxidized wet beaded carbon black (202) according to any one of aspects 23 or 24, wherein the oxidized wet beaded carbon black (202) has a volatile content measured at 950° C. of 1.5 to 20 wt.-%, such as 1 to 10 wt.-%, 1.5 to 10 wt.-%, 1.5 to 20 wt.-%, 2 to 10 wt.-%, 2 to 15 wt.-%, 2.5 to 10 wt.-%, 3 to 7 wt.-%, or 3.5 to 7 wt.-%.

26. The oxidized wet beaded carbon black (202) according to any one of aspects 23 to 25, wherein the iodine adsorption number of the oxidized wet beaded carbon black (202) is 30 to 80 mg/g, preferably 40 to 70 mg/g, more preferably 45 to 65 mg/g.

27. The oxidized wet beaded carbon black (202) according to any one of aspects 23 to 26, wherein the oxidized wet beaded carbon black (202) has statistical thickness surface area (STSA) determined according to ASTM D6556-17 in a range from 15 to 500 m²/g, preferably from 20 to 400 m²/g, more preferably from 30 to 300 m²/g, even more preferably from 40 to 200 m²/g, most preferably from 50 to 150 m²/g. 39.

28 The oxidized wet beaded carbon black (202) according to any one of aspects 23 to 27, wherein the fines content of the oxidized wet beaded carbon black (202) is 0.1 to 50%, preferably 1 to 10%, and more preferably 1 to 5%.

29. The oxidized wet beaded carbon black (202) according to any one of aspects 23 to 28, wherein the pH-value of the oxidized wet beaded carbon black (202) is below 7, such as 2 to 6, preferably 2 to 5, more preferably 2 to 3, even more preferably 2.4 to 2.9, most preferably 2.7 to 2.9.

1. A process for the production of oxidized wet beaded carbon black comprising the following steps:
(a) providing carbon black,
(b) wet beading the carbon black obtained in step (a) to obtain wet beaded carbon black, and
(c) oxidizing the wet beaded carbon black obtained in step (b) in a reaction chamber to obtain oxidized wet beaded carbon black.

2. The process according to claim 1, wherein step (c) uses ozone (217), H₂O₂ and/or NOx for the oxidation.

3. The process according to claim 1, wherein 0.1 to 95 wt.-% of the gas present in the reaction chamber is ozone, and/or the concentration of ozone in the reaction chamber is 1 to 300 g/m³.

4. The process according to claim 1, wherein the ozone concentration is adjusted/controlled in such a way that the volatile content measured at 950° C. is 1 to 25 wt.-%.

5. The process according to claim 1, wherein the oxidation in step (c) is carried out in a screw conveyor comprising the reaction chamber mentioned in step (c), the speed of the screw being 0.01 to 10 rpm.

6. The process according to claim 5, wherein the wet beaded carbon black obtained in step (a) is supplied to the screw conveyor.

7. The process according to claim 1, wherein the weight ratio of the wet beaded carbon black to ozone for the oxidation in step (c) is 1:1 to 15:1, and/or the weight ratio of the wet beaded carbon black to ozone for the oxidation in step (c) is over 1.

8. The process according to claim 1, wherein the temperature for the oxidation in step (c) is 10 to 60° C.

9. The process according to claim 1, wherein the wet beading (b) comprises:
(b1) treating the carbon black with water to obtain wet carbon black,
(b2) beading the wet carbon black to obtain beaded carbon black comprising water, and
(b3) drying the beaded carbon black to obtain wet beaded carbon black, wherein the water content of the wet beaded carbon black is less than 10 wt.-%.

10. The process according to claim 9, wherein the water comprises a binder.

11. An oxidized wet beaded carbon black having a volatile content measured at 950° C. of 1 to 25 wt.-% and an average pellet crush strength of pellets with a diameter of from 0.71 to 1.0 mm of from 4 to 80 cN.

12. The oxidized wet beaded carbon black according to claim 11, wherein the oxidized wet beaded carbon black has an average pellet crush strength of pellets with a diameter of 1.0 to 1.4 mm of from 4 to 80 cN, and/or wherein the oxidized wet beaded carbon black has an average pellet crush strength of pellets with a diameter of 1.4 to 1.7 mm of from 3 to 80 cN.

13. The oxidized wet beaded carbon black according to claim 11, wherein the oxidized wet beaded carbon black has a volatile content measured at 950° C. of 1.5 to 20 wt.-%.

14. The oxidized wet beaded carbon black according to claim 1, wherein the oxidized wet beaded carbon black has statistical thickness surface area (STSA) determined according to ASTM D6556-17 in a range from 15 to 500 m²/g.

15. The oxidized wet beaded carbon black according to claim 1, wherein the fines content of the oxidized wet beaded carbon black is 0.1 to 50%.
